(19) United States
(12) Patent Application Publication
(10) Pub. No.: US 2016/0005133 A1
(43) Pub. Date: Jan. 7, 2016

(54) Communications Relay Portal

(71) Applicant: Michael Flynn, Newport Beach, CA (US)

(72) Inventor: Michael Flynn, Newport Beach, CA (US)

(21) Appl. No.: 14/321,628

(22) Filed: Jul. 1, 2014

(51) Int. Cl. G06Q 50/00; H04L 29/06

(52) U.S. Cl. CPC G06Q 50/01; H04L 63/083; H04L 63/12

(57) ABSTRACT

A system and method is provided for disseminating user contact information to requesting parties comprising the steps of creating a user account (personal or business) by receiving user contact information, verifying a user phone number, transmitting a verification code to a user device associated with the user phone number, receiving the verification code back from the user, and prompting the user to create a password. A user email is then generated that is associated with the user account and contains the user phone number, and optionally, an extension indicating a business account. Upon receiving an email at the user email address from a requesting party, the user phone number from the user email address is cross-referenced with existing user accounts to determine if the requested user account exists, and additionally, whether a business account exists. A formatted virtual business card is then generated for the requested user account.

### RELATED U.S. APPLICATION DATA

This application claims priority to Provisional Application No. 61/841,426, filed Jul. 1, 2013.

### FIELD OF THE INVENTION

The present invention relates to communication systems, more specifically, communications portals for relaying information.

### SUMMARY OF THE INVENTION

The present invention presents a communications portal which utilizes a software-driven relay mail system operating within the cloud. It allows a client to deliver a diverse and complete set of personal/business contact information to any party requesting said information. The system software functions by matching user/account information sent by a requester to active accounts in the system, then returning information based on matched searches. An account-holding client is identified primarily by their phone number, which in some instances is augmented by an extension or additional data-carrying code (e.g. business contact information). Account setup and message relay revolves around the use of said identifiers within the context of standard e-mail addresses and URL/web addresses. These augmentable identifiers allow for hierarchical access permissions, allowing account-holding clients to disseminate variable quantities of contact information as desired. As well, this delivery process may be executed by the client using an auto-reply scheme, which is particularly advantageous in that it relieves a client of the need for a separate email account associated with their identifying numeric contact number, while promoting cost effectiveness. During account setup, the client's ten-digit phone number is verifiable via the software's two-step authentication method.

The invention is particularly suited for the business-oriented client, and the realm of communication within which business persons must operate on a regular basis. The software-based system accomplishes its goals of highly organized, scalable data dissemination via standard e-mailing methods and existing vCard technology to transfer the data from a dedicated server to the client or information requester. The system uniquely streamlines the digital business card by consolidating a plurality of client profiles into one web-based profile page accessible by the client on a personal/business account basis.

### BRIEF DESCRIPTION OF THE DRAWINGS

FIG. 1 illustrates a high-level schematic of the communication methods occurring between client/requester and software-driven server/database.

FIG. 2 illustrates a flowchart which describes the step by step method of personal/business account setup.

FIG. 3 illustrates an exemplary online screenshot of an exemplary personal-account home page with various data input field options.

FIG. 4 illustrates an exemplary online screenshot of a exemplary business account home page with various data input field options.

FIG. 5 illustrates a flowchart which describes the step by step method by which a requester acquires an appropriate vCard via the software-driven relay mail system.

FIG. 6 illustrates a flowchart which describes the system's method of redirecting a requester from a customer account link address to the actual customer website.

FIG. 7 illustrates two flowcharts that summarize several account setup options, including the communication portal's “single number” identification method using an extension and/or alphabetical shorthand.

FIG. 8 illustrates an exemplary online screenshot which displays several profile access options made available to a requester.

FIG. 9 illustrates two logic charts that summarize the security option and international access option made available to an account-holding client.

### DETAILED DESCRIPTION

The present invention provides a communications portal that links active account holder contact information (which resides in the system's “single number” customer database) to any requesting party. A systematic data exchange is provided that allows the client to use any personal computing device to connect with the system's software-driven database via cloud computing. The result is quick, streamlined access to all of the client's various information destinations in an efficient and reliable manner and with considerable options/adjustability, while maintaining simplification of the multitude of customer addresses.

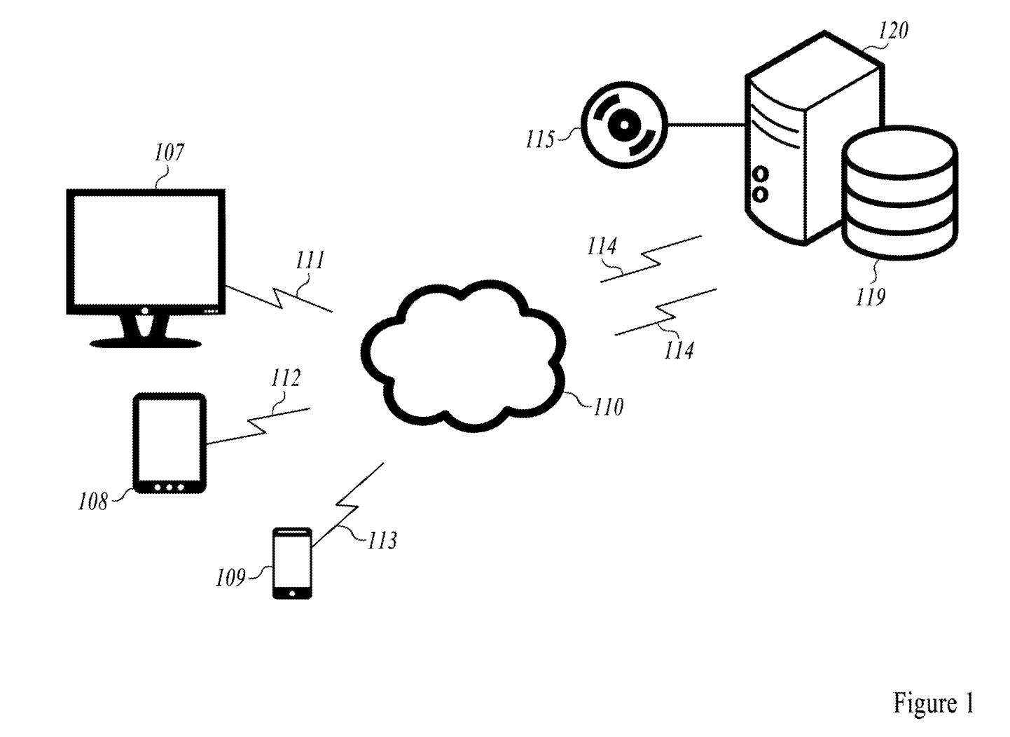

FIG. 1 illustrates a high-level overview of the communication methods occurring between client/requester and software-driven server/database during data exchanges. A data requester must utilize this schema and related lines of communication to complete said data exchange. Henceforth, the use of the term “requester” shall apply to any party who actively seeks said data via the lines of communication which are relevant to the successful functionality of the communications portal system. The portal's relay system comprises a server 120 and database 119 which are directed by the protocol set forth by customized software 115. The database holds active user account information, accumulating it over time with each new user/account registration. The portal software is designed to selectively access database contents, deliver auto-responses, carry out phone number verification, prepare appropriate vCards, etc. Lines 114 indicate the transmission of data between the communications portal and the cloud 110. In the context of requester activity, tracing data exchange flow between user and portal, the schema for system functionality begins with the inputting of data/requests into personal computing devices, including personal computers 107, tablets 108, and smartphones 109. Lines 111-113 indicate the wireless transmission of data between said devices and the cloud, respectively. The cloud provides an obvious nexus where said user input meets said system contents/functionality in an active and/or passive exchange (e.g. a relay email exchange which recalls and delivers user account information) through communicative web content.

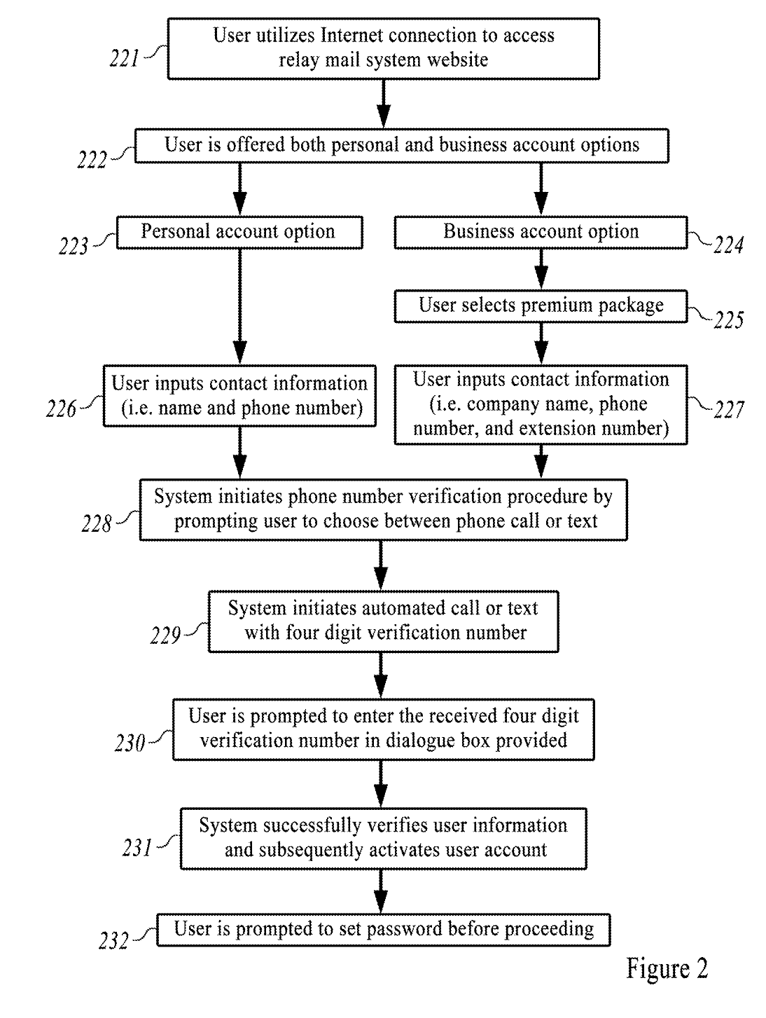

FIG. 2 illustrates a flowchart which describes the step by step method of personal/business account setup. Registration step 221 states that, as per the data exchange schema described in FIG. 1, a user must initially gain access to the Internet using one of the aforementioned personal computing devices, then navigate to the communications portal/relay mail system website via their browser. Registration step 222 states how, upon reaching the system's website and clicking a “new user” registration button, the user is first presented with two account type options—personal 223 or business 224. Registration step 225 shows that if the user opts for a business account, they are then presented with premium package options, and must select an enhanced subscription before continuing. As indicated by registration step 226, if opting for the personal account option, the user is taken straight to a data field page wherein the user inputs their name and phone number. Registration step 227 indicates the presence of an extra data field for the business account registrant—a default extension number (this will be the default account extension), in addition to fields for company name and phone number. The personal option provides only one default profile to deliver to requester's, while the business option provides both a default profile and the ability to add unlimited profiles/vCards, hence the need for an extension which will later be used as an augmenting identifier for the user's existing ten-digit number.

At this point in the registration procedure, as stated by registration step 228, the system (having received the prospective client's contact information) initiates a phone number verification procedure by prompting the user to choose between a phone call or a text message. Registration step 229 describes how the system initiates an automated call or text message to the user's provided phone number, based on the decision in the previous step. This automated communication carries a four digit verification number (or more generally, “verification code”), which the user should take note of upon hearing/seeing it on their phone. The user should then return to their browser window and prepare to follow the next system prompt. Registration step 230 describes the system's prompting of the user to enter the received four digit verification number (or code) in the dialogue box provided. The verification code can be comprised of numbers or letters and have varying lengths (e.g. four digit or more). Once the user has followed this prompt, the system can successfully verify the user's information and subsequently activate their new account, as stated in registration step 231. This activation includes generating a user email address associated with the user and containing the user phone number. Step 232 shows a minor successive step whereby the user must set a password before proceeding to actual site usage. At this point the active user is free to edit their account information by creating a default profile and/or multiple profiles if subscribing to a business account.

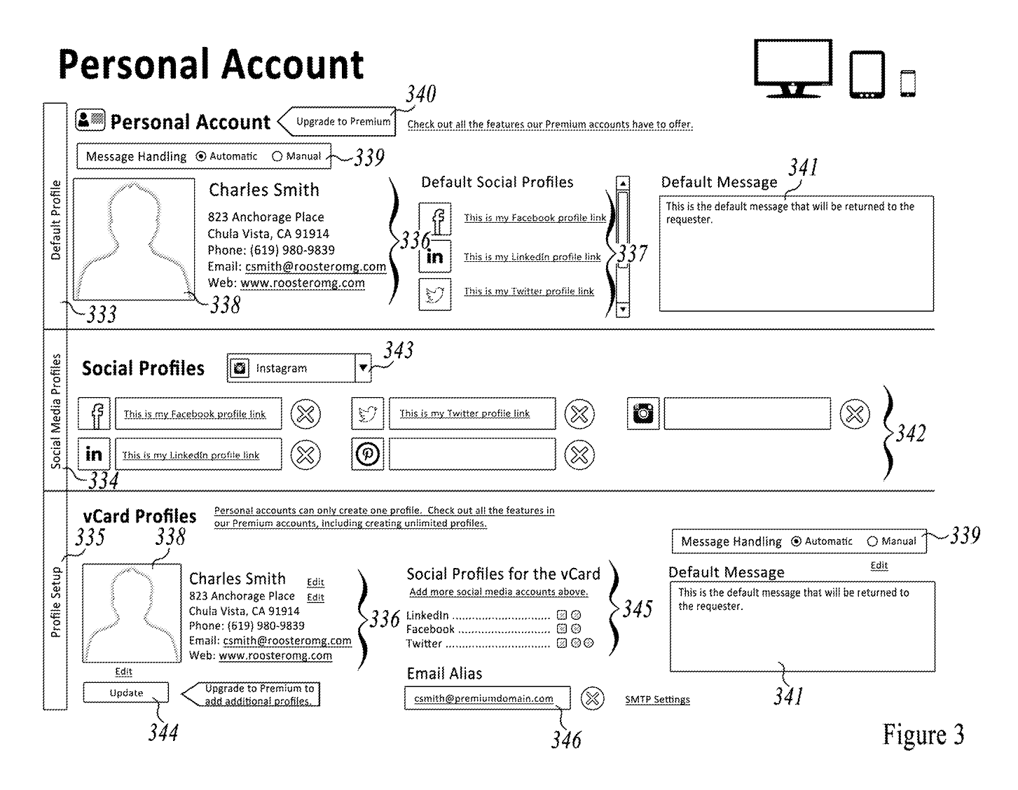

FIG. 3 illustrates an exemplary online screenshot of a typical personal account home page with various data input field options. This profile page comprises three main groups of information/active data fields, the “default profile” area 333, the “social media profile” area 334, and the “profile setup” area 335. The default profile area shows contact information that the user has already entered within the system. It further comprises a user profile picture 338 at the far left of the page (to the right of the default profile tab 333), and a non-editable contact information area 336 directly to the right of it. This area of text contains such user information as name, address, phone number, personal/work email address, and web address. Directly to the right of the contact information are the user's default social profiles 337. Shown below the line of text reading “Default Social Profiles”, these social profiles are shown as boxes containing the proprietary icons associated with each social network, e.g. Facebook, LinkedIn, Twitter, etc. Directly to the right of these profiles is a large data field for the user's default message 341.

As indicated by the text entered into the field in the screenshot, it is “the default message that will be returned to the requester.” This message is found in the auto-response emails which carry user contact information. Directly above the user profile picture 338, a message handling decision area 339 shows the automatic or manual option made available to the user. Although this particular area is non-editable, it shows the result of the user's ability to control whether or not auto-responses are used to reply to requesters interested in this particular user account. The editable version of this box is found lower on the page. Directly above and to the right of this message handling area 339, the communications portal self-advertises with an “Upgrade to Premium” button 340, linking the user to more information/registration for the business account option.

The social media profiles area 334 is an area of profile enhancement on the page. It further comprises a drop-down menu of social media platforms 343 from which the user can pick and choose additional links for their default profile. These changes are reflected below the drop-down menu, in the current social profiles area 342. In this profile example, as evidenced by the available links in the default social profiles area 337 above, only three platforms have been selected by the user and possess active links. This area 342 allows the user to delete current available profiles as needed. The profile setup area 335 is also an area of profile enhancement on the page. Once again, directly to the right of the profile setup tab 335, it displays the user profile picture 338, here with the added ability of changing the picture via re-upload. Directly to the right of this picture is an editable version of the contact information area. Here, the user may update all fields as necessary, by utilizing “edit” buttons.

Directly to the right of the editable information area are the available social profiles for the vCard 345. Here, the user may add additional social media accounts to their profile page, making them available for use in the dropdown menu 343. An editable default message field 341 is shown to the right of the aforementioned social profiles area 345. Directly above this field lies the editable version of the message handling decision area 339 mentioned above. Here the user may click on either the automatic or manual setting to dictate how their profile responds to prospective requesters. Directly beneath the available social profiles for the vCard 345 is an “Email Alias” 346 for the user. This editable email address is provided as the official user address within the communications portal system. An “Update” button 344 found directly beneath the user profile picture 338 allows the changes made in the profile setup area to be applied and reflected in the default profile area 333.

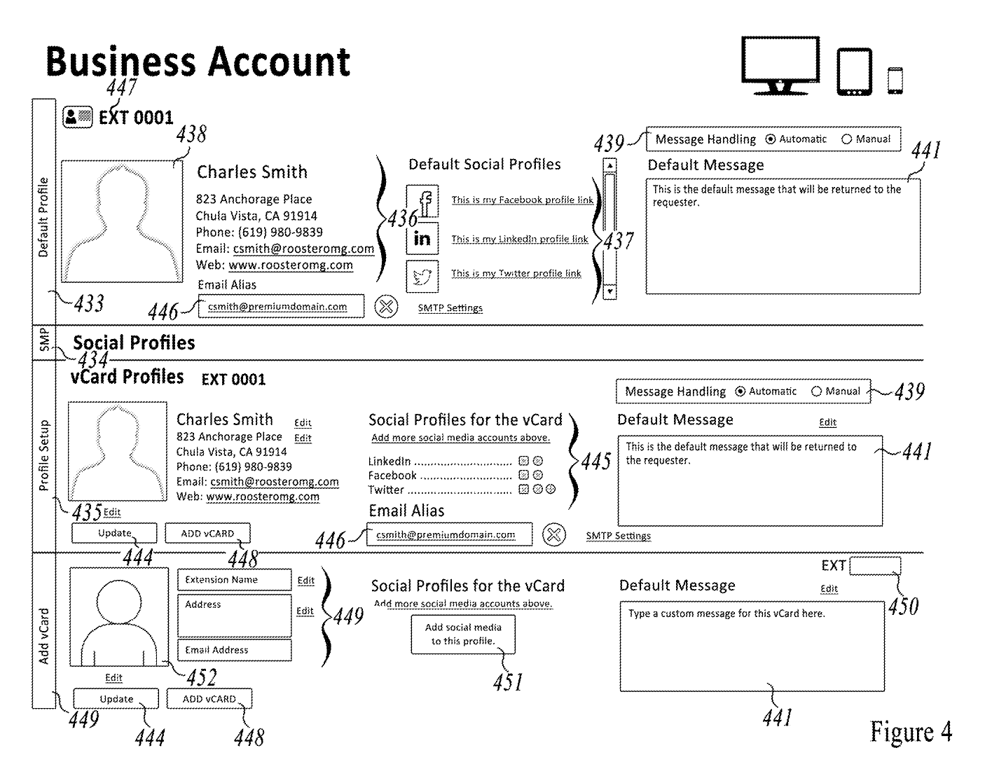

FIG. 4 illustrates an exemplary online screenshot of a typical business account home page with various data input field options. This profile page comprises four main groups of information/active data fields, the “default profile” area 433, the “social media profile” area 434, the “profile setup” area 435, and the “add vCard” area. It should be noted that the business account profile type depicted in FIG. 4 shares all of the core features mentioned in FIG. 3 which are offered by the personal account type. As such, there are many recurring elements that will be mentioned again—their value not necessarily reiterated. Said mirrored elements possess the same or similar visual characteristics as described in the previous figure description. As in the personal account page, the default profile area depicts contact information that the user has already entered within the system, and reflects all of the information that will be sent out to a requester for this profile. It further comprises a user profile picture 438, a non-editable contact information area 436, a “default social profiles” area 437 and a default message data field 441. These elements provide the same information as those sharing nomenclature in FIG. 3, in approximately the same locations on the web page.

In contrast, the business account page's non-editable message handling decision area 439 is found at the far right of the page, while vertically at a similar location. Additionally, the link for the user's “Email Alias” 446 can be found directly beneath the contact information area 436. Most importantly, the profile extension number 447 (found directly above the profile picture 438) is a novel element on the business account page. It is a numeric identifier for (in this example) the default profile. For the purpose of profile delivery to a requesting party, said extension is attached to the phone number portion of a business user's identifying email address/web address and used as an augmenting identifier for the given profile (one among a plurality, if the business user so chooses). This method and it's functional characteristics will be described in greater detail by later figures. Directly beneath the “Default Profile” tab, the “social media profiles” tab 434 (shown with the abbreviation “SMP”) has been abridged here; the characteristics of this area (as described by FIG. 3) remain the same. As well, the profile setup area 435 beneath the social media profiles area mirrors that of the personal account with only one deviation/addition—that is the presence of an “Add vCard” button 448. Clicking this would enable the user to add an entire new profile, or plurality of profiles, in addition to the default profile described above.

For example, assuming the Default profile was largely used as a vessel for personal contact, a “company” or “employee” profile could be designated as business-oriented profiles, used in the capacity of office work organization, or employee information-management in a large scale company setting, or interstate, networked organization. The “Add vCard” area 449 directly beneath the profile setup area 435 visually encapsulates the options involved with said adding of profiles. FIG. 4 shows an updatable, undefined profile picture 452 directly to the right of the tab designating the add vCard area 449. Clicking the edit button directly below the picture allows the user to designate a desired image for the new profile. Directly to the right of this picture, an editable contact information area allows the user to actively populate such fields as “Extension Name”, “Address”, and “Email Address”, etc. with appropriate information. Additional fields not pictured in this screenshot would be made available to the user during an actual profile establishment. A social media profiles addition button 451 lying directly to the right of said fields allows the user to add the social media accounts he/she desires to associate with the new account. Directly to the right of this button, an editable default message field 441 appears again, providing a place where the user can designate a custom message for the new vCard. Directly above and to the right of this field, an editable “EXT” field 450 allows the user to designate the identifying numeric extension to be associated with this new profile. After a plurality of profiles have been created, the business account user has unlimited access to viewing, disseminating, and editing them.

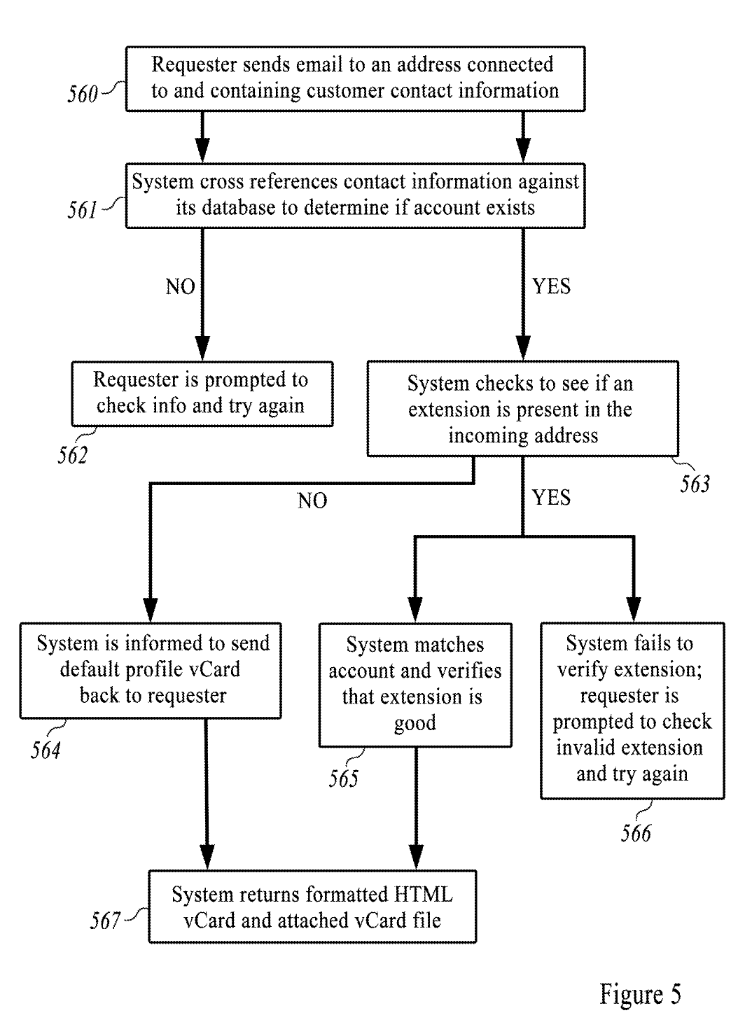

FIG. 5 illustrates a flowchart which describes the step by step method by which a requester acquires an appropriate vCard via the software-driven relay mail system. Requester step 560 shows that the initial catalyst for user profile dissemination is an email sent by an interested party (the requester). Said requester populates the message destination field with the numeric email address of an active account-holding client. Via requester step 561, the communications portal system cross-references the account number associated with said email address against its database of customer accounts to determine if the account exists. If the account does not exist, the requester is prompted to check the info and try again—as shown by requester step 562. If the account exists, requester step 563 shows that the system will then check to see if an extension is present in the incoming address. Again, the presence of an extension implies that a business account has been emailed. If no extension is found, the system is informed to send a default profile vCard back to the requester, as stated in requester step 564. Successful requests to a personal account will always yield this result; the system returns a formatted HTML vCard and attached vCard file back to the requester, as indicated by requester step 567. If an extension is found, the system then attempts to verify it. Requester step 566 shows that failure to verify the extension results in the system prompting the requester to check the invalid extension and try again. Requester step 565 indicates an account match by the system, whereby the extension is found to be good. Again, requester step 567 indicates the result of this successful transaction, this time in association with a business account, whereby the system returns a formatted HTML vCard and attached vCard file.

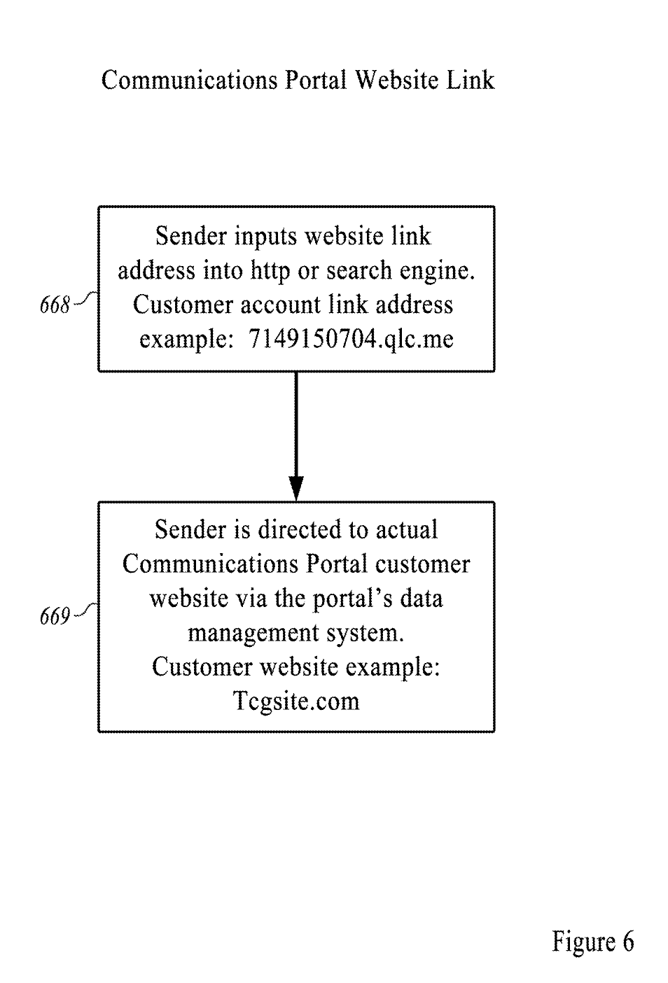

FIG. 6 illustrates a flowchart which describes the system's method of redirecting a requester from a customer account link address (which includes the customer's ten-digit phone number) to the actual customer website. Link redirection step 668 shows that a requester may input a simple numeric website link address into the search bar of their browser. An example of such a customer account link address would be: 7149150704.qlc.me. Link redirection step 669 shows that after inputting this link address, the requester is directed to the actual communications portal customer website via the portal's data management system. An example of the customer website source address would be: Tcgsite.com. A redirection method of this nature makes use of the single number customer account database, making the client's numeric identifier all the more ubiquitous in relation to the website and system in general. Rather than typing a vague abbreviated address, the requester is given a distinct numeric redirector.

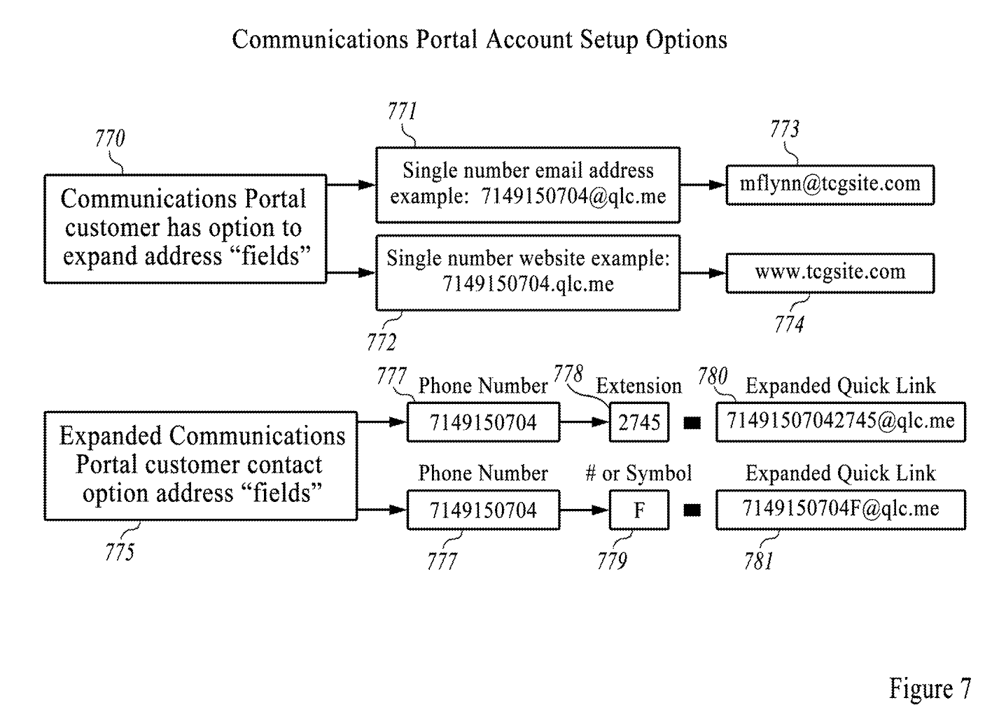

FIG. 7 illustrates two flowcharts that summarize several account setup options, and the expandable nature of the communication portal's “single number” identification method using an extension and/or alphabetical shorthand. In elaborating upon the ideas presented in the previous figure, the method of augmented/abbreviated account identification numbers/addresses is displayed. The account setup chart nearest the top of the page flows horizontally and to the right, starting with option 770, which states that a communications portal customer has the option to expand address “fields”. As an example of this, option 771 shows that a customer's single number email address, e.g. 7149150704@qlc.me, can dually be represented by the address seen in option 773, that is: mflynn@tcgsite.com. Similarly, option 772 shows that a customer's single number website address, e.g. 7149150704.qlc.me, can dually be represented by the address seen in option 774, that is: www.tcgsite.com.

Below this chart, a second account setup chart flowing in the same direction starts with option 775, which states the fact that a communications portal customer can expand address “fields” during contact option configuration. Option 777 shows a customer's ten-digit phone number, e.g. 7149150704. Option 778 presents a possible extension number, e.g. 2745. Option 780 shows the expanded quick link address that is yielded by combining the two aforementioned options, that is: 71491507042745@qlc.me. Similarly, the phone number mentioned in option 777 can be augmented by an alphabetical symbol, e.g. “F”, as shown in option 779, to yield the address in option 781, that is: 7149150704F@qlc.me. In this way, a plurality of nomenclature options—all revolving around the single number identifier methodology, are made available to a communications portal customer for use in a multitude of scenarios.

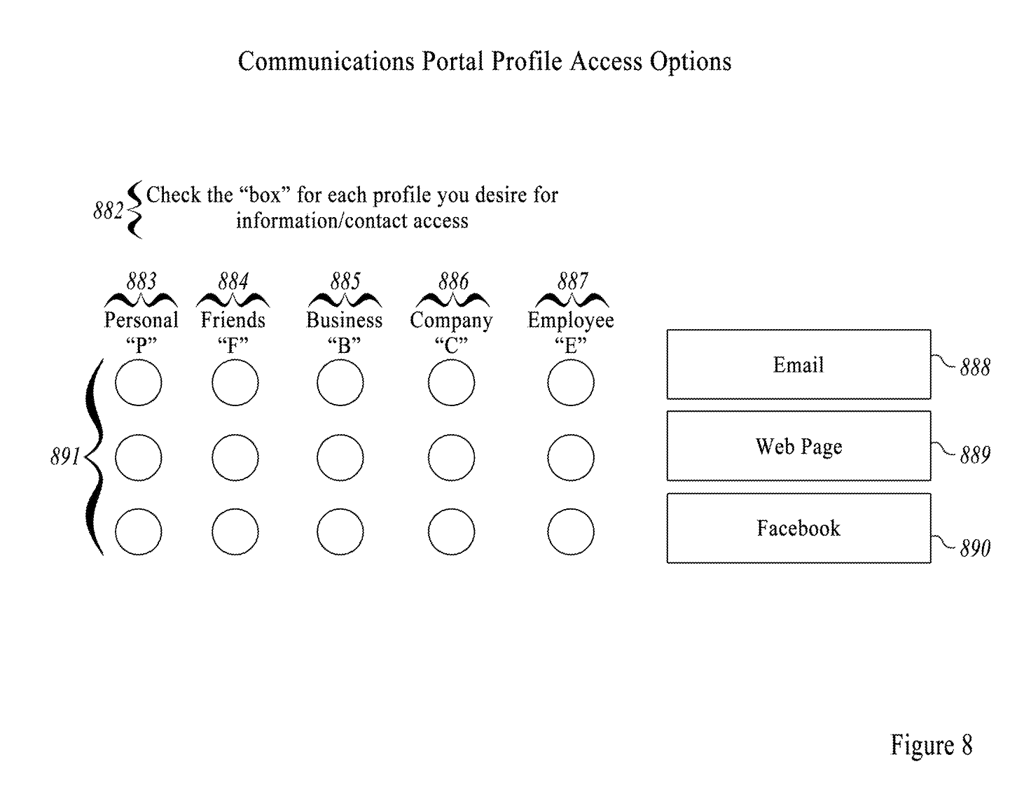

FIG. 8 illustrates an exemplary online screenshot which displays several profile access options made available to a requester. Continuing with various account setup options, this figure shows an example of a customer form for establishing a number of different profile access levels for their contact information. Here, the customer decides what is to be shared with a prospective requester. Instruction 882 directs the customer to check the circle for each profile he/she desires for information/contact access. Said circles are found in columns/rows in the area encompassed by input field 891. The three-rows of circles correspond horizontally to three contact destinations, which are (in this example) email 888, web page 889, and Facebook 890. Seen as five columns, the circles correspond vertically to five different account profiles, which are (in this example) Personal (“P”) 883. Friends (“F”) 884, Business (“B”) 885, Company (“C”) 886, and Employee (“E”) 887. The input field works as a table whereby the user can dictate which combinations of profile types and destinations will be made available to a requester. For example checking row “Web Page” 889 and row “Facebook” 890 within column “F” 884 would permit requester access to a vCard containing contact information from the customer's “Friends” profile, which contained the customer's web page address and Facebook account address. It should be noted that other profiles can be set up as well, such as “S” for Supplier, “D” for Dating, etc.

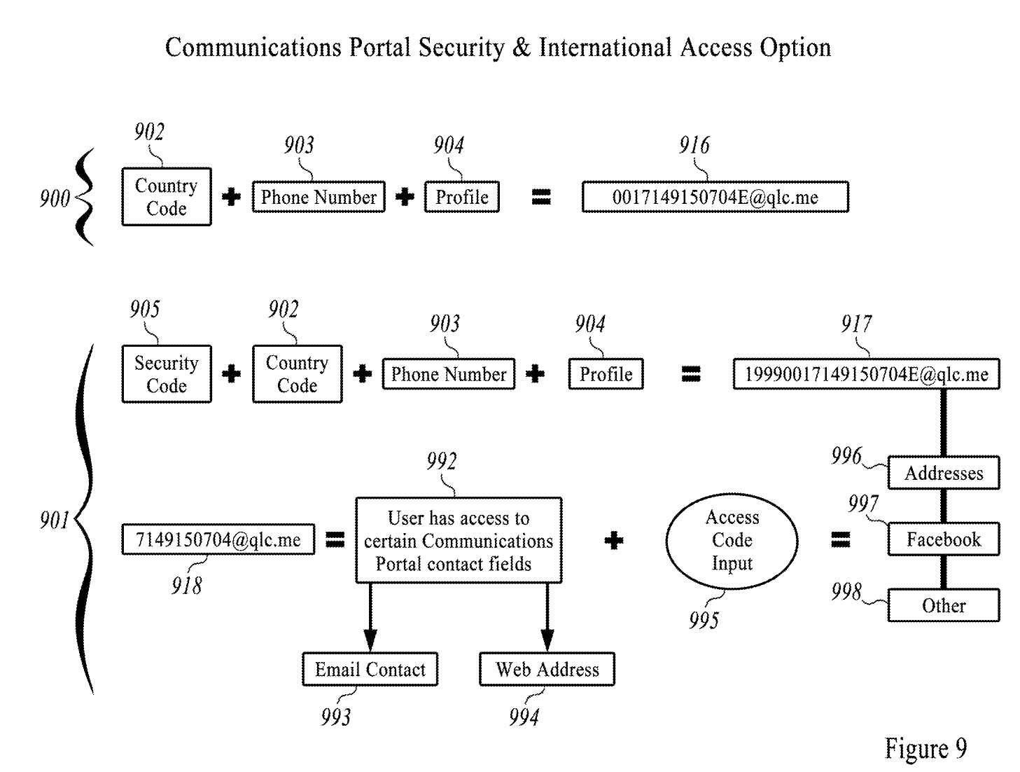

FIG. 9 illustrates two logic charts that summarize the security option and international access option made available to an account-holding client. Logic chart 900 comprises the relevant components that make up an augmented numeric-alphabetical customer email address 916 in an international context. These components are the customer's country code 902, phone number 903, and profile type 904. In this example, the combination of these numeric-alphabetical items, where country code=001, phone number=7149150704, and profile type=“E”, yields a final augmented numeric-alphabetical address: 0017149150704E@qlc.me. This final address is what a communications portal customer would use within the relay mail system.

The first row of logic chart 901 comprises the relevant components that make up a secured, augmented numeric-alphabetical customer email address 917 with a security code, in an international context. These components are the customer's personally designated security code 905, country code 902, phone number 903, and profile type 904. In this example, the combination of these numeric-alphabetical items, where the security code=1999, yields a final secured, augmented numeric-alphabetical address: 19990017149150704E@qlc.me. The second row of logic chart 901 further elaborates upon the security aspect of the communications portal by showing an example of the levels of access that result from the establishment of a secured, augmented numeric-alphabetical customer address. Access logic 992 shows that under basic circumstances, a user's access to a single number address garners them access to certain communications portal contact fields . . . e.g. email contact 993 and a web address 994. If the user successfully follows through with security code input 995, it follows that the full range of contact destinations/profiles, e.g. addresses 996, Facebook 997, other options 998 now become available, via the full coded address 917. It should be noted that the system can auto-translate contact content with recognition of the customer's country code, as well as have a translate option on the communications portal website for the customer.

While there have been described herein what are considered to be preferred and exemplary embodiments of the present invention, other modifications of the invention shall be apparent to those skilled in the art from the teachings herein.

What is claimed is:

1. A method for disseminating user contact information to requesting parties comprising: creating a user account for a user, further comprising offering personal and business account options, receiving user contact information, verifying a user phone number, transmitting a verification code to a user device associated with the user phone number, receiving the verification code back from the user, prompting the user to create a password;
generating a user email address associated with the user account and containing the user phone number, and optionally, an extension indicating a business account;
receiving an email at the user email address from a requesting party;
cross-referencing the user phone number from the user email address with existing user accounts to determine if the requested user account exists, and additionally, whether a business account exists;
generating a formatted vCard for the requested user account.

2. The method of claim 1 wherein the user contact information is the user's ten-digit phone number.

3. The method of claim 1, further comprising generating a website address associated with the user account, wherein said website address can be utilized by the requesting party to acquire the formatted vCard.

4. The method of claim 1 wherein the user contact information is transmitted to the requesting party via an email relay.

5. The method of claim 1 wherein the user device is a smartphone, tablet, or personal computer.

6. The method of claim 1 wherein a business account-holding user has the ability to create a plurality of contact profiles, each identifiable by a numeric extension.

7. The method of claim 1 wherein the business profile contains additional information beyond a personal account, such as company name and business phone number.

8. A method for disseminating user contact information to requesting parties comprising: creating a user account for a user,
generating a user email address associated with the user account and containing the user phone number, and optionally, an extension indicating a business account;
receiving an email at the user email address from a requesting party;
cross-referencing the user phone number from the user email address with existing user accounts to determine if the requested user account exists, and additionally, whether a business account exists;
generating a formatted vCard for the requested user account.

9. The method of claim 1, wherein the creating a user account further comprises the steps of offering personal and business account options, receiving user contact information, verifying a user phone number, transmitting a verification code to a user device associated with the user phone number, receiving the verification code back from the user, and prompting the user to create a password.

10. The method of claim 1 wherein the user contact information is the user's ten-digit phone number.

11. The method of claim 1, further comprising generating a website address associated with the user account, wherein said website address can be utilized by the requesting party to acquire the formatted vCard.

12. The method of claim 1 wherein the user contact information is transmitted to the requesting party via an email relay.

13. The method of claim 1 wherein the user device is a smartphone, tablet, or personal computer.

14. The method of claim 1 wherein a business account-holding user has the ability to create a plurality of contact profiles, each identifiable by a numeric extension.

15. The method of claim 1 wherein the business profile contains additional information beyond a personal account, such as company name and business phone number.
